(19) United States
(12) Patent Application Publication
(10) Pub. No.: US 2019/0020404 A1
(43) Pub. Date: Jan. 17, 2019

(54) Utilization of National Cellular Infrastructure for UAV Command and Control

(71) Applicant: David Wayne Russell, Winter Garden, FL (US)

(72) Inventor: David Wayne Russell, Winter Garden, FL (US)

(73) Assignee: USDrobotics Inc., Orlando, FL (US)

(21) Appl. No.: 16/067,581

(22) PCT Filed: Dec. 30, 2016
(86) PCT No.: PCT/US2016/069423

§ 371 Date: Jun. 29, 2018

Related U.S. Application Data
(60) Provisional application No. 62/275,717, filed on Jan. 6, 2016.

(51) Int. Cl. H04B 7/185; H04W 4/38; H04W 4/44; G08G 5/00; F41H 11/02; F41H 13/00; B64C 39/02; G01S 19/11; G01S 13/78

(52) U.S. Cl. CPC H04B 7/18506; H04W 4/38; H04W 4/44; G08G 5/0082; G08G 5/0069; H04W 92/10; F41H 11/02; F41H 13/005; B64C 39/024; G01S 19/11; G01S 13/78; G08G 5/0013

(57) ABSTRACT

Unmanned Aerial Vehicles also known as UAVs or Drones, either autonomous or remotely piloted, may be fitted with an Identify Friend or Foe (IFF) transponder for tracking and identification. Remotely piloted drones require a high bandwidth RF transceiver for video and/or control inputs, but the IFF system does not. Fully autonomous vehicles might utilize only the low bandwidth IFF transponder. This invention utilizes the existing cellular network and physical infrastructure to provide UAV command and control functionality over most of the national area.

### CROSS-REFERENCE TO RELATED APPLICATIONS

U.S. 62/275,717 Jan. 6, 2016

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD

This invention relates generally to cellular radio infrastructure and more specifically to the utilization of cellular infrastructure for UAV command and control.

### BACKGROUND

Piloted drones require high bandwidth RF transceivers for pilot video and/or control inputs and are loath to add IFF data to that stream. Domestic (non-military) transceivers are most often point to point connections in the unlicensed Industrial/Scientific/Medical (ISM) bands. IFF data may need to be transmitted to entities such as the FAA in addition to just the pilot control console, such that the point to point connection is insufficient to implement the functionality of the IFF transponder even though it may be low bandwidth.

Fully autonomous vehicles may be assisted by Enhanced GPS (E-GPS) transponders or other detectable beacons at known locations within their area of operation. Both types of vehicles may be fitted with an IFF transponder for tracking and identification. UAV threat assessment and enforcement of UAV registration laws depend on detecting UAVs over wide areas and correlating that data with the IFF transponders. A methodology is needed where all of these functions may be efficiently implemented with lower cost on a nation-wide basis by utilization of the existing cellular network and infrastructure.

### BRIEF SUMMARY OF THE INVENTION

Cell phone towers are ideal locations for IFF transponder and identification modules because A) they are ubiquitous, B) they are already placed in advantageous geographic locations for wide and complete coverage, C) they already have power systems which may be utilized, and D) they provide a transceiver linkage to nationwide cellular networks. In one embodiment, an IFF transceiver based on a given RF frequency or band is placed within or attached to an unmanned vehicle such as but not limited to an Unmanned Aerial Vehicle (UAV), drone, automated vehicle, or Automated Aerial Vehicle (AAV) or Application Specific Autonomous Vehicle (ASAV).

A transceiver module is also mounted to and powered by a cellular network tower or fixed location of which the geographic location is known to a high degree of accuracy. In one embodiment the module may contain any combination of functions such as but not limited to Enhanced GPS (E-GPS) transmitter, IFF transceiver, 3D imaging camera system, RADAR, LIDAR, IR, RF, magnetic, or visible light beacon, and cellular network transceiver and interface.

In one embodiment the E-GPS transmitter assists autonomous vehicles by providing them with a high accuracy reading of their location. This may be a service provided for free by a national agency such as but not limited to the FAA, or it may be a pay-for-use system that might be provided by the drone operating company or a third party. In any case, the system may be encrypted or otherwise obfuscated such that only licensed, registered, or otherwise approved users have access to the data. The IFF system is advantageous if this is a third party system, as it allows the module to read and identify the licensed users within the area which provides subsequent billing information much like cell-phone usage. If a pay-for-use system is implemented, more than one module, belonging to different third party providers, might be installed on a single tower or location by different providers, much like the existing cellular network itself.

In one embodiment the network transponder may transmit a short request for response often referred to as a “ping”. The transponder may either “ping” periodically or simply listen for IFF transponder transmissions within the Area of Operation (AO). Constant transmission of the transponder signal may cause an unacceptable drain on power resources, so this tradeoff will be determined by the system developers designing the particular network.

The coverage area of one module may be roughly or closely defined, such that the IFF transmission from the vehicle is not charged until it is physically within the AO of a given tower, but multiple towers might be receiving the IFF data at the same time. This locational aspect of the cellular system might be used advantageously to provide an alternative location fix to vehicles within the AO to validate the GPS location information and thereby prevent spoofing of the GPS signal. Similarly IR, RF, magnetic, or visible light beacons on the towers, because they are at known geographic locations might also provide additional means of location validation even though they may or may not be more accurate than the GPS signal.

When the IFF transponder information is received by the network module, it may contain many types of information such as but not limited to vehicle identifier, estimated location, trackpath identifier, vehicle type, vehicle capabilities, and/or vehicle status. This information may be logged to multiple entities either in real time or stored for later retrieval or both. The FCC data servers, for example, could compare the vehicle's current location with its projected location as filed in its Air Traffic Control (ATC) flight plan, and utilize that position update within a 4D Autorouter to better integrate new flight plans, to update information to pilots in the area, and/or warn other vehicles and agencies of deviation from the flight plan. This information could be utilized by a UAV specific cockpit instrument and display or added into the FAA's ADS-B or other flight control system.

In order to enforce UAV registration laws and recommendations, detection of the UAV itself is first required. Detectors placed on cellular towers and locations are generally placed in advantageous locations for coverage of the AO. The detector in the module may be a 3D camera system, or other system such as but not limited to RADAR or LIDAR. The end result of the detector is to locate small moving objects within the AO and correlate them with the IFF data, and if possible to distinguish between a small UAV and a bird, for example. Day and night coverage would be optimal.

If a moving object is detected that does not correlate with the IFF data, actions could be initiated such as but not limited to warning agencies monitoring the particular AO, updating threat assessments, launching manned aircraft, UAVs or AAVs, updating ADS-B and other flight information systems, adding the anomaly to 4D autorouters compiling new flight plans, and deploying countermeasures.

To provide optimal coverage, ASAVs designed as interceptor craft could be launched autonomously to intercept, identify, track, and if necessary deploy countermeasures against the target vehicle. This also provides for the type of error where the vehicle is legal and identified, but the IFF transponder has ceased operation or has reduced signal strength such that the signal is not reaching the network module. Once the ASAV is close enough to identify either the tail number of the craft or receive its transponder data, it could then retransmit this data to the network module enabling correlation of the vehicle. The location, speed, and heading of the vehicle could then be passed on to other neighboring AOs so that they would not need to launch their own ASAV to identify the vehicle again, although in some locations that may be desired.

In another embodiment the ASAV might be directed to follow the target craft to its destination providing continuous coverage and correlation data. Enforcement violations such as but not limited to non-compliance or faulty equipment requiring repair could be sent to the registered owner. If the unit is not registered, the ASAV might transmit a low power Return to Base or Kill Switch command to the target to attempt to remove it from the airspace and possibly confiscate the platform. The ASAV's cameras might also be able to identify the target and thereby know of its capabilities or if not recognized increase the level of the threat assessment.

In another embodiment land or aerial vehicles could implement some subset of the tower's module capabilities to patrol areas out of reach of the cellular towers and provide greater coverage as well as less predictable enforcement capability.

In another embodiment large objects, such as but not limited to helicopters, ultralights, or other aircraft may also be detected and reported to the administrative systems to update the data model representing the AO, watch for potential collision paths, and update warning and tracking systems for aircraft in general.

The data transmitted by the IFF transponder may be direct to the cellular network, including the network module and appropriate agencies or retransmitted through the network by the module.

In order to provide coverage of the entire AO, multiple cameras and/or multiple modules may need to be placed on the tower and/or placed in additional locations within the AO but still utilizing the closest or highest signal strength network tower for communications.

Once the E-GPS transceivers are in position, paths between towers that have continuous coverage become natural drone corridors for autonomous vehicles and the 4D autorouters computing flight plans can take maximum effect of the additional GPS accuracy by routing a greater number of vehicles through these corridors.

### BRIEF DESCRIPTION OF THE DRAWINGS

The following detailed description illustrates embodiments of the invention by way of example and not by way of limitation. The description clearly enables one skilled in the art to make and use the disclosure, describes several embodiments, adaptations, variations, alternatives, and use of the disclosure, including what is currently believed to be the best mode of carrying out the disclosure. The disclosure is described as applied to an exemplary embodiment namely, systems and methods of utilization of cellular networks for UAV command and control. However, it is contemplated that this disclosure has general application to vehicle management systems in industrial, commercial, military, and residential applications.

As used herein, an element or step recited in the singular and preceded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

The detailed description is described with reference to the accompanying figures. In the figures, the left-most digit(s) of a reference number identifies the figure in which the reference number first appears. The use of the same reference numbers in different figures indicates similar or identical components or features.

The novel features believed characteristic of the illustrative embodiments are set forth in the appended claims. The illustrative embodiments, however, as well as a preferred mode of use, further objectives, and features thereof will best be understood by reference to the following detailed description of illustrative embodiments of the present disclosure when read in conjunction with the accompanying drawings, wherein:

FIG. 1 depicts an overall schematic diagram of the components of utilization of the national cellular infrastructure for UAV command and control.

### DETAILED DESCRIPTION OF INVENTION

In accordance with an embodiment of the present invention, a system employing cellular networks and/or infrastructure is provided to facilitate command and control of remotely piloted and autonomous vehicles. A module controller with cellular network interface and direction and ranging sensor such as but not limited to 3D cameras may be used to respond to Identify Friend or Foe (IFF) messages transmitted from vehicles and correlate the data and transmit location, bearing, and other data to one or more entities of an overall air traffic control system. The data from one or more 3D cameras may be pre-processed but additional hardware or software systems to present only the correlation data needed by the module controller. Enhanced Global Positioning Satellite transmitters may be included to assist in the navigation and control of autonomous vehicles and/or surface GPS systems. System power may be provided by the cellular network tower. A vehicle remotely piloted or autonomous platform may be staged to act as an interceptor with imaging or other capability to identify any detected craft not correlated with IFF transponder data within the area of operation. An interceptor may be armed with some combination of countermeasures such as but not limited to Return to Base or Kill Switch IFF codes, RF jammers, missiles, projectile weapons, LASERs, entanglement, or directed electromagnetic pulse projectors under the direction of air traffic controllers. Ground based countermeasures may be installed to provide action against any detected craft within the area of operation as guided by air traffic controllers. An IFF transceiver may be installed to communicate with any IFF systems not connected directly to the cellular network. Some combination of the subsystem components may be installed in areas in addition to the cellular tower or structure to enhance coverage of the area of operation. Network modules and some combination of subsystems may be installed on a temporary basis to create a temporary area of operation. Areas of Enhanced GPS coverage may essentially create drone corridors for high traffic utilization because of the contiguous enhanced coverage. High bandwidth RF communications capability may be added to the cellular network tower to assist certain piloted drones such as but not limited to emergency response or law enforcement in Beyond Line of Sight situations. Recharging stations may be added to the cellular tower to aid some battery limited systems. Drone operators may be charged for utilization of services. Land or air vehicles utilizing the same or some subset of the cellular infrastructure functions may patrol areas not within reach of the monitoring systems implemented on the cellular towers themselves to provide greater monitoring and less predictable enforcement capabilities. Additional capabilities such as but not limited to beacons including RF, IR, magnetic and/or visible light constant or modulated may be used as navigation aids or backup navigation correlation to validate the GPS fix and prevent GPS “Spoofing.”

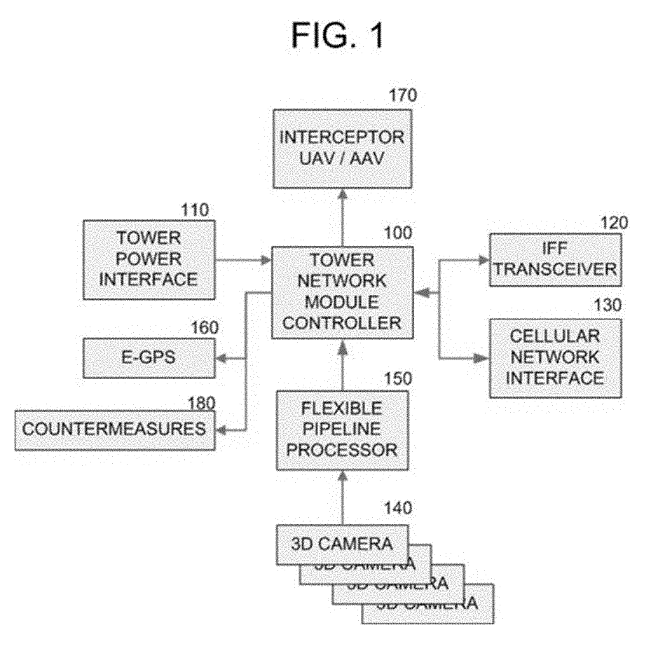

FIG. 1 depicts the major components of a network module to link into the cell phone infrastructure. The module's main controller 100 is a Central Processing Unit (CPU) and memory running software for this application. It would tie into some existing power system 110 but may also include battery backup and/or alternative power sources. It may interface to an IFF Transceiver 120 unless the IFF system implemented connects directly to the cellular network.

The module controller may broadcast a “ping” or request for information, and all IFF modules in the area would respond at least once. In addition, the platform may transmit its IFF information periodically in the blind. This would be useful if the module was implemented to track the IFF platforms without giving away its own location.

The network module also contains an interface to one or more cellular networks 130 low power transmission would be effective and perhaps necessary on the tower itself. If the IFF system is implemented as part of the cellular network, the network interface might not receive the data directly from the platform, but it may be relayed to the module as part of the data distribution network.

To detect UAVs in the Area of Operation (AO) in one embodiment a series of 3D cameras 140 are deployed at different angles, elevations, and declinations. The number of cameras would be dependent on the geometry of the AO. In other implementations radar or LIDAR or other distance and bearing ranging instruments might be used. Even other types of imagers including 2D cameras might be used if simple bearing information is sufficient to identify the target within the mission profile. In other embodiments fewer cameras might be used if they had pan-tilt-zoom capabilities and could be directed by the module controller.

Each camera or imaging system may create huge amounts of data. This data might overwhelm a standard CPU with software, so a hardware accelerator such as but not limited to a Flexible Pipeline Processor (FPP) could be implemented to sort through the data and only present the data required to the module controller. In cases like this the FPP might simply discard 90% of the data in order to focus on the small moving targets. This could also be improved by implementing object and/or pattern recognition functions into the cameras themselves or utilize cameras with built-in functionality.

As part of the module deployment and perhaps to help pay for it, an E-GPS transmitter 160 might also be embedded within the module. The transmitter operates with little overhead from the module controller after initialization.

In another embodiment an interceptor unmanned aerial vehicle or autonomous aerial vehicle 170 might be stationed on or near the network module. It would be docked to its own power/recharge/refueling system and await targeting information from the module controller or overall network controllers. The vehicle could be autonomous or remote piloted, but is staged as an interceptor to investigate any anomalous or unregistered vehicles detected in the airspace. In addition, other countermeasures 180 such as but not limited to RF jammers, missiles, projectile weapons, LASERs, entanglement, or directed electromagnetic pulse projectors could be called into play by the overall network command and control system.

In another embodiment, the system could also facilitate the operation of autonomous ground vehicles in a similar manner.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. Further, different illustrative embodiments may provide different benefits as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the figures. For example, the functions of two blocks shown in succession may be executed substantially concurrently, or the functions of the blocks may sometimes be executed in the reverse order, depending upon the functionality involved.

The invention claimed is:

1-17. (canceled)

18. A system for monitoring unmanned aerial vehicles, comprising:
sensors co-located with a cellular network tower, the sensors configured to detect unmanned aerial vehicles operating in the vicinity of the cellular network tower;
a transceiver co-located with the cellular network tower, the transceiver configured to receive identifying information communicated by the unmanned aerial vehicles operating in the vicinity of the cellular network tower; and
a controller configured to correlate data from the sensors regarding the unmanned aerial vehicles with the received identifying information so as to determine whether any of the detected unmanned aerial vehicles are unauthorized.

19. The system according to claim 18, wherein a detected unmanned aerial vehicle is determined to be unauthorized when identifying information for the detected unmanned aerial vehicle is not correlated to the data from the sensors for the detected unmanned aerial vehicle.

20. The system according to claim 18, wherein the data from the sensors and the identifying information include location information for the unmanned aerial vehicles operating in the vicinity of the cellular network tower.

21. The system according to claim 18, wherein power is provided to the system by the cellular network tower.

22. The system according to claim 18, further comprising an interface to a cellular network, wherein the interface is configured to communicate the received identifying information via the cellular network.

23. The system according to claim 18, wherein the sensors comprise one or more direction sensors and one or more ranging sensors.

24. The system according to claim 18, wherein the sensors comprise one or more three-dimensional cameras.

25. The system according to claim 18, wherein data from the one or more three-dimensional cameras is pre-processed prior to provision to the controller.

26. The system according to claim 18, wherein the identifying information is communicated via IFF (Identify Friend or Foe) messages.

27. The system according to claim 18, further comprising one or more Enhanced Global Positioning Satellite (E-GPS) transmitters configured to assist with navigation of the unmanned aerial vehicles.

28. The system according to claim 18, wherein areas of E-GPS coverage form traffic corridors for the unmanned aerial vehicles.

29. The system according to claim 18, further comprising countermeasures configured to take action in response to a determination that a detected unmanned aerial vehicles is unauthorized.

30. The system according to claim 29, wherein the countermeasures comprise an unmanned interceptor vehicle staged at the cellular network tower and equipped with imaging capability and configured obtain images of any unmanned aerial vehicles that are identified as unlicensed or not identified by the identifying information.

31. The system according to claim 29, wherein the countermeasures comprise unmanned interceptor armed with one or more countermeasures selected from the group consisting of: a return to base code; a kill switch code; a radio frequency jammer: a projectile weapon; a laser; a entanglement countermeasure; and a directed electromagnetic pulse projector.

32. The system according to claim 29, wherein the countermeasures are ground based.

33. The system according to claim 18, wherein an unmanned aerial vehicle recharging station is provided at the cellular network tower.

34. A method of monitoring unmanned aerial vehicles, comprising:
detecting unmanned aerial vehicles operating in the vicinity of the cellular network tower using sensors;
receiving identifying information communicated by the unmanned aerial vehicles operating in the vicinity of the cellular network tower; and
correlating data regarding the detected unmanned aerial vehicles with the received identifying information so as to determine whether any of the detected unmanned aerial vehicles are unauthorized.

35. The method according to claim 34, wherein a detected unmanned aerial vehicle is determined to be unauthorized when the detected unmanned aerial vehicle is not identified by the identifying information.

36. The method according to claim 34, wherein the data from the sensors and the identifying information include location information for the unmanned aerial vehicles operating in the vicinity of the cellular network tower.

37. The method according to claim 34, further comprising communicating the received identifying information via an interface to a cellular network.

38. The method according to claim 34, further comprising assisting navigation of the unmanned aerial vehicles using one or more Enhanced Global Positioning Satellite (E-GPS) transmitters.

39. The method according to claim 34, further comprising taking action in response to a determination that a detected unmanned aerial vehicles is unauthorized.

40. The method according to claim 34, further comprising providing an unmanned aerial vehicle recharging station at the cellular network tower.
